(19) United States
(12) Patent Application Publication
(10) Pub. No.: US 2025/0191324 A1
(43) Pub. Date: Jun. 12, 2025

(54) METHOD AND SYSTEM FOR DETECTING CONTAMINANTS ATTACHED TO CAMERA LENS

(71) Applicant: Korea Electronics Technology Institute, Seongnam-si (KR)

(72) Inventors: Haeng Seon SON, Seongnam-si (KR); Kyoung Won MIN, Seongnam-si (KR); Seon Young LEE, Seoul (KR); Jin Man PARK, Gwangju-si (KR); Young Bo SHIM, Seongnam-si (KR); Gi Ho SUNG, Seongnam-si (KR)

(73) Assignee: Korea Electronics Technology Institute, Seongnam-si (KR)

(21) Appl. No.: 18/961,433

(22) Filed: Nov. 26, 2024

(30) Foreign Application Priority Data
Dec. 6, 2023 (KR) 10-2023-0175299

(51) Int. Cl. G06V 10/25; G06V 10/26; G06V 10/32; G06V 20/70

(52) U.S. Cl. CPC G06V 10/25; G06V 10/26; G06V 10/32; G06V 20/70

(57) ABSTRACT

Provided are a method and a system for detecting contaminants attached to a camera lens. A camera contaminant detection method according to an embodiment includes: receiving an image through a camera; pre-processing the inputted image; and identifying a contamination region to which contaminants are attached and a normal region to which contaminants are not attached in the pre-processed image. Accordingly, by automatically detecting whether contaminants are attached to a camera for autonomous driving and the location of attachment, auto-cleaning or contamination alarms may be performed to prevent degradation of recognition performance caused by contaminants on the camera for autonomous driving.

### CLAIM OF PRIORITY

This application is based on and claims priority under 35 U.S.C. § 119 to Korean Patent Application No. 10-2023-0175299, filed on Dec. 6, 2023, in the Korean Intellectual Property Office, the disclosure of which is herein incorporated by reference in its entirety.

### BACKGROUND

### Field

The disclosure relates to a camera image processing technology for intelligent vehicles, and more particularly, to a method and a system for detecting contaminants on a camera for an intelligent vehicle, which is capable of autonomously recognizing whether contaminants are attached to a camera lens and regions of attachment.

### Description of Related Art

A camera sensor for autonomous driving is a very important component to perform the function of recognizing objects existing on a road, such as vehicles, pedestrians, lanes, etc. Even a small foreign substance may cause fatal errors in the camera, and contaminants which obstruct the field of vision of the camera, such as bird droppings, insect carcass, leaves, etc., are frequently attached to the lens of the camera.

To solve this problem, the camera lens should be cleaned, but the function of automatically recognizing contamination on the camera lens, which is a prerequisite for cleaning, is not provided. Accordingly, when contaminants are attached to the camera lens and the recognition performance of the camera is degraded, a user may recognize the corresponding condition and should directly clean the lens.

However, this method has a problem that it may not be applied to intelligent vehicles evolving into autonomous vehicles.

### SUMMARY

The disclosure has been developed in order to solve the above-described problems, and an object of the disclosure is to provide, as a solution for preventing degradation of recognition performance caused by contaminants in a camera for autonomous driving, a method and a system for automatically recognizing whether contaminants are attached to a camera and regions of attachment.

To achieve the above-described object, a camera contaminant detection method according to an embodiment may include: receiving an image through a camera; pre-processing the inputted image; and identifying a contamination region to which contaminants are attached and a normal region to which contaminants are not attached in the pre-processed image.

The contamination region may be divided into an opaque region where the field of vision is completely obstructed by contaminants, and a translucent region where the field of vision is imperfectly obstructed by contaminants.

The translucent region may include a region that is occluded by transparent or translucent contaminants, or a periphery region in the opaque region through which light passes in part.

Identifying may include identifying the opaque region, the translucent region, and the normal region in the pre-processed image through semantic segmentation.

According to the disclosure, the camera contaminant detection method may further include: accumulating results of identifying the opaque region, the translucent region, and the normal region; and extracting contaminants based on the accumulated results of identifying.

Accumulating may include identifying an opaque region, a translucent region, and a normal region for each pixel with respect to N images including a current image and past continuous images, and accumulating the results of identifying.

Extracting may include extracting, as contaminants, a pixel which is most frequently identified as an opaque region and a pixel which is most frequently identified as a translucent region in the N images.

Pre-processing may include performing histogram equalization and scaling with respect to the inputted image.

Pre-processing may include: converting the image from an RGB format to a YUV format and performing equalization with respect to a Y channel; and scaling an image size to a size sufficient to process semantic segmentation.

According to another aspect of the disclosure, there is provided a camera contaminant detection system including: an input unit configured to receive an image through a camera; a pre-processing unit configured to pre-process the inputted image; and an identification unit configured to identify a contamination region to which contaminants are attached and a normal region to which contaminants are not attached in the pre-processed image.

According to still another aspect of the disclosure, there is provided a camera contaminant detection method including: identifying a contamination region to which contaminants are attached and a normal region to which contaminants are not attached in a camera image; accumulating results of identifying the contamination region and the normal region; and extracting contaminants based on the accumulated results of identifying.

As described above, according to embodiments of the disclosure, by automatically detecting whether contaminants are attached to a camera for autonomous driving and the location of attachment, auto-cleaning or contamination alarms may be performed to prevent degradation of recognition performance caused by contaminants on the camera for autonomous driving.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a camera lens contaminant detection system according to an embodiment of the disclosure;

FIG. 2 is a view illustrating examples of kinds of contaminants attached to a camera lens;

FIG. 3 is a view illustrating a result of performing semantic segmentation;

FIG. 4 is a view illustrating a method for determining regions by voting; and

FIG. 5 is a view illustrating a camera contaminant detection method according to another embodiment of the disclosure.

### DETAILED DESCRIPTION

Hereinafter, the disclosure will be described in more detail with reference to the accompanying drawings.

Cameras for autonomous driving are sensors in which it is important to secure the field of vision, and their performance is very influenced by contaminants. Therefore, the autonomous driving cameras are required to automatically recognize whether contaminants are attached and locations of attachment in order to prevent degradation of recognition performance caused by contaminants.

Embodiments of the disclosure propose a method and a system for detecting contaminants attached to a camera lens. The disclosure relates to a technology that autonomously detects whether contaminants are attached to a camera lens and regions of attachment, and thereby performs auto-cleaning or contamination alarms to prevent degradation of recognition performance of a camera for autonomous driving.

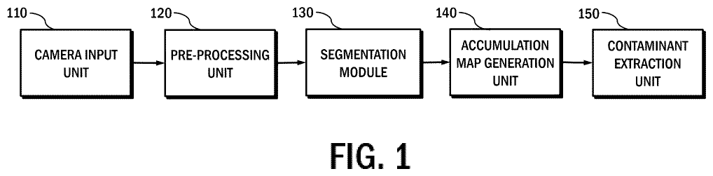

FIG. 1 is a view illustrating a configuration of a camera lens contaminant detection system according to an embodiment of the disclosure. The camera lens contaminant detection system according to an embodiment of the disclosure may include a camera input unit 110, a pre-processing unit 120, a segmentation module 130, an accumulation map generation unit 140, and a contaminant extraction unit 150 as shown in the drawing.

The camera input unit 110 may receive an image which is generated through photographing by a camera for autonomous driving. The inputted image is delivered to the pre-processing unit 120.

The pre-processing unit 120 performs histogram equalization and scaling with respect to the image inputted from the camera input unit 110. To perform histogram equalization, the pre-processing unit 120 converts the image from a RGB format to a YUV format, and then, performs equalization with respect to the Y channel. Thereafter, the pre-processing unit 120 scales the image size to a size for the segmentation module 130, which will be described below, to process sematic segmentation.

The segmentation module 130 is configured to divide the image pre-processed by the pre-processing unit 120 into a region to which contaminants are attached and a region to which contaminants are not attached. The segmentation module 130 may divide the pre-processed image into the corresponding regions through a semantic segmentation algorithm which is a deep learning algorithm.

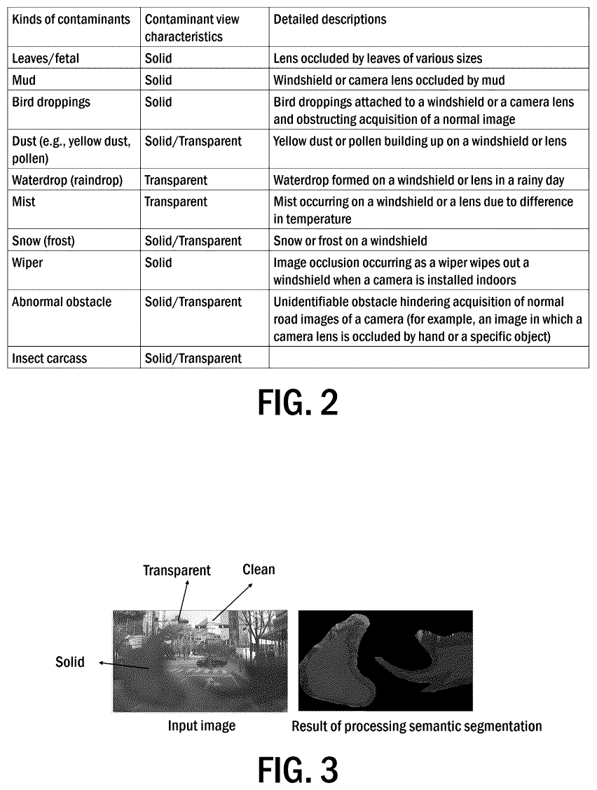

FIG. 2 illustrates kinds of contaminants which are attached to the camera lens and obstruct the field of vision. In an embodiment of the disclosure, the kinds of contaminants are not identified, but instead, the view characteristics that the image has due to contaminants are identified.

Specifically, the region to which the contaminants are attached, the contamination region, may be divided into a Solid region and a Transparent region. The Solid region refers to an opaque region where the field of vision is completely obstructed by opaque contaminants and a clear view is not secured.

The Transparent region may be a translucent region where the field of vision is imperfectly obstructed by contaminants. The Transparent region occurs when contaminants are transparent or translucent like waterdrop, or occurs on a periphery of an opaque region through which light penetrates in part. In the Transparent region, a blurry image is seen.

In an embodiment of the disclosure, as shown in FIG. 3, the segmentation module 130 may give a Clean label to a normal region to which contaminants are not attached, may give a Solid label to a region (opaque region) to which opaque contaminants are attached to make the image unidentifiable, and may give a Transparent label to a region (translucent region) to which transparent/translucent contaminants are attached to make a part of a background image blurred.

Referring back to FIG. 1, a result of performing segmentation for one image may give rise to an error due to the problem of accuracy of the algorithm. Accordingly, in order to improve the accuracy of detection of contaminants and locations, results of processing several images may be accumulated and it may be determined whether contaminants are detected.

To achieve this, the accumulation map generation unit 140 accumulates results of distinguishing the Clean region, the Solid region, and the Transparent region by the segmentation module 130. The results may be accumulated by voting.

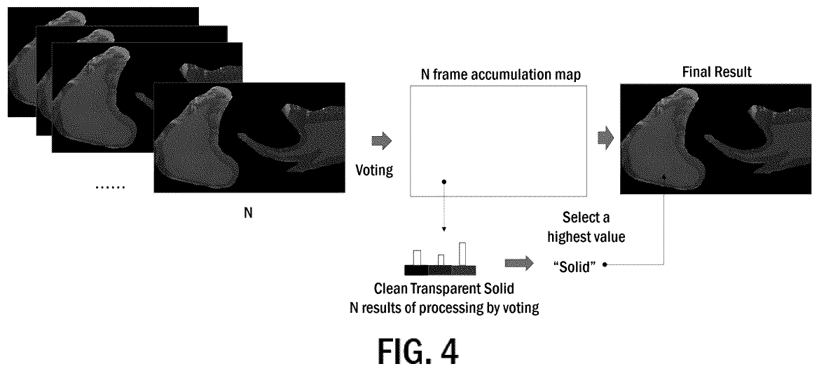

Specifically, the accumulation map generation unit 140 may determine a Clean region, a Solid region, and a Transparent region for each pixel of N images including a current image and continuous past images, and may perform voting to accumulate the results of determining. N is variable according to a processing speed. FIG. 4 illustrates accumulation of results of distinguishing a Clean region, a Solid region, and a Transparent region through voting by the accumulation map generation unit 140 on the left view and the middle view.

The contaminant extraction unit 150 extracts contaminants based on the result of voting, which is the accumulated results of distinguishing by the accumulation map generation unit 140. Specifically, the contaminant extraction unit 140 may extract, from the N images, a pixel which is most frequently voted as a Clean region as a Clean region, a pixel which is most frequently voted as a Solid region as a Solid region, and a pixel which is most frequently voted as a Transparent region as a Transparent region. FIG. 4 illustrates the region extraction method by the contaminant extraction unit 150 on the right view. The Solid region and the Transparent region are treated as contaminants.

When the results of voting are tied, the priority may be given in the order of Solid-Transparent-Clean. For example, when the number of times of voting for the Clean region and the number of times of voting for the Solid region are the same, the corresponding pixel is extracted as a Solid region.

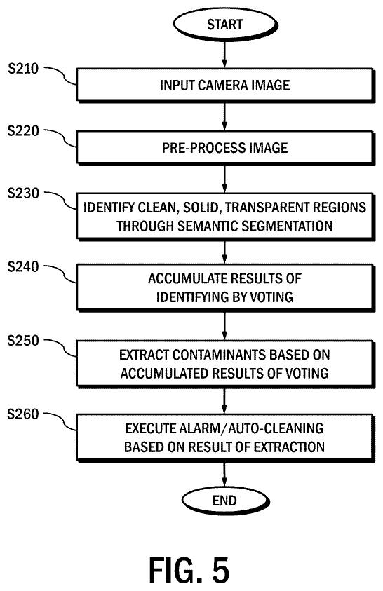

FIG. 5 is a flowchart of a camera contaminant detection method according to another embodiment of the disclosure.

To detect camera lens contaminants, the camera input unit 110 receives an image generated through photographing by the camera for autonomous driving (S210), and the pre-processing unit 120 performs necessary pre-processing with respect to the image inputted at step S210 (S220).

The segmentation module 130 identifies a Clean region, a Solid region, and a Transparent region in the image pre-processed at step S220 by using a semantic segmentation algorithm (S230).

The accumulation map generation unit 140 accumulates the results of identifying at step S230 by voting (S240). The contaminant extraction unit 150 extracts contaminants based on the accumulated results of voting at step S240 (S250).

The result of extracting contaminants at step S250 may be used to sound a contaminant alarm or to perform an auto cleaning function (S260). The corresponding functions may be executed based on whether contaminants are attached to the lens, and in particularly, the corresponding functions may be performed only when the location of attachment of contaminants is within a main recognition range of the camera.

Up to now, the method and the system for detecting contaminants attached to a camera lens have been described in detail with reference to preferred embodiments.

In the above-described embodiments, the method and the system may automatically recognize whether contaminants are attached and the location of attachment to prevent degradation of recognition performance caused by contaminants on a camera for autonomous driving.

Accordingly, by automatically detecting whether contaminants are attached to a camera for autonomous driving and the location of attachment, auto-cleaning or contamination alarms may be performed to prevent degradation of recognition performance caused by contaminants on the camera for autonomous driving.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A camera contaminant detection method comprising:
receiving an image through a camera;
pre-processing the inputted image; and
identifying a contamination region to which contaminants are attached and a normal region to which contaminants are not attached in the pre-processed image.

2. The camera contaminant detection method of claim 1, wherein the contamination region is divided into an opaque region where the field of vision is completely obstructed by contaminants, and a translucent region where the field of vision is imperfectly obstructed by contaminants.

3. The camera contaminant detection method of claim 2, wherein the translucent region comprises a region that is occluded by transparent or translucent contaminants, or a periphery region in the opaque region through which light passes in part.

4. The camera contaminant detection method of claim 2, wherein identifying comprises identifying the opaque region, the translucent region, and the normal region in the pre-processed image through semantic segmentation.

5. The camera contaminant detection method of claim 4, further comprising:
accumulating results of identifying the opaque region, the translucent region, and the normal region; and
extracting contaminants based on the accumulated results of identifying.

6. The camera contaminant detection method of claim 5, wherein accumulating comprises identifying an opaque region, a translucent region, and a normal region for each pixel with respect to N images comprising a current image and past continuous images, and accumulating the results of identifying.

7. The camera contaminant detection method of claim 6, wherein extracting comprises extracting, as contaminants, a pixel which is most frequently identified as an opaque region and a pixel which is most frequently identified as a translucent region in the N images.

8. The camera contaminant detection method of claim 5, wherein pre-processing comprises performing histogram equalization and scaling with respect to the inputted image.

9. The camera contaminant detection method of claim 8, wherein pre-processing comprises:
converting the image from an RGB format to a YUV format and performing equalization with respect to a Y channel; and
scaling an image size to a size sufficient to process semantic segmentation.

10. A camera contaminant detection system comprising:
an input unit configured to receive an image through a camera;
a pre-processing unit configured to pre-process the inputted image; and
an identification unit configured to identify a contamination region to which contaminants are attached and a normal region to which contaminants are not attached in the pre-processed image.

11. A camera contaminant detection method comprising:
identifying a contamination region to which contaminants are attached and a normal region to which contaminants are not attached in a camera image;
accumulating results of identifying the contamination region and the normal region; and
extracting contaminants based on the accumulated results of identifying.
